(19) United States
(12) Patent Application Publication
(10) Pub. No.: US 2017/0135291 A1
(43) Pub. Date: May 18, 2017

(54) CROP MATERIAL

(71) Applicant: Nine IP Limited, Auckland (NZ)

(72) Inventors: Jonathan Dallas TOYE, Auckland (NZ); Nicola Ann Forster, Auckland (NZ)

(21) Appl. No.: 15/319,077

(22) PCT Filed: Jun. 16, 2015
(86) PCT No.: PCT/IB2015/054531

§ 371 Date: Dec. 15, 2016

(30) Foreign Application Priority Data
Jun. 16, 2014 (NZ) 626307
Jul. 18, 2014 (NZ) 627663

(51) Int. Cl. A01G 13/02

(52) U.S. Cl. CPC A01G 13/0206; A01G 13/0225; A01G 2013/002

(57) ABSTRACT

A crop material is woven in a leno weave configuration from weft tapes and groups of warp elements, the warp elements in each group cross at a cross-over point between adjacent weft tapes, and the adjacent groups of warp elements spaced apart across the weft at a distance greater than about 8 mm.

### RELATED APPLICATIONS

This application derives priority from New Zealand patent application numbers 626307 and 627633, the contents of which are incorporated herein by reference.

### FIELD OF INVENTION

The invention relates to crop materials such as those used as windbreaks or for providing crop shading and particularly but not exclusively to the crop materials having improved wind permeability.

### BACKGROUND

Crop materials, such as netting and woven fabrics, may be placed near plants such as annual plants, perennial plants, fruit trees, or grape vines, to protect them from birds, insects, excessive sun, wind, or hail. Typically the materials are supported over the plant(s) and/or as a vertical and/or angled wall or walls near the plant(s), by for example cables or wires between posts positioned along the rows of plants in a garden, field crop, orchard or vineyard.

Under wind load, especially high wind load, crop materials or the structures supporting them may be damaged. For example, the supporting structures may be blown over, the means of fixing the fabrics to structures may be torn out of the fabric, or the fabric itself may tear.

### SUMMARY OF INVENTION

An object of the present invention is to provide a crop material that will ameliorate some of the effects of wind loading upon the material, or at least provide the industry with a useful choice.

In one aspect the present invention may broadly consist in a crop material woven in a leno weave configuration from weft tapes and groups of warp elements spaced apart across the weft and with the warp elements in each group of warp elements crossing at a cross-over point between adjacent weft tapes and adjacent groups of warp elements spaced across the weft at greater than about 8 mm.

In some embodiments adjacent groups of warp elements are spaced across the weft at greater than about 12 mm, greater than about 16 mm greater than about 18 mm, or greater than about 24 mm.

The adjacent groups of warp elements are spaced across the weft at a spacing that may allow wind to pass through the material between weft tapes more easily than for an otherwise equivalent material with the same coverage but closer warp elements. That is, for a given coverage, the material of the invention may have higher wind permeability and/or wind permeability which increases with wind speed, relative to a similar material with closer spaced warp elements.

The adjacent groups of warp elements are spaced across the weft at a spacing that may allow weft tapes to move under increased speed, to increase volumetric wind flow through the material greater than due to increase in wind speed alone.

Materials of the invention comprising weft tapes comprised of materials flexible enough, and warp elements sufficiently spaced in the weft direction, may allow the weft tapes to move for example billow and/or at least partially twist or rotate under wind load conditions. The wind permeability of the fabric may increase or decrease as wind load increases or decreases. Increasing the spacing between the adjacent groups of warp elements, thus increasing the length of weft tape segments between adjacent groups of warp elements will increase wind permeability of the fabric at a given wind load.

In some embodiments tape movement occurs at wind loading of more than 5, 8, 10, 15, 20, 25, 30, 35, 40, 45, 50, 55, 60, 65, 70, 80, 90, 100, 110, 120, 130, 140 knots. In some embodiments tape movement occurs at wind loading of less than 5, 8, 10, 15, 20, 25, 30, 35, 40, 45, 50, 55, 60, 65, 70, 80, 90, 100, 110, 120, 130, 140 knots. In some embodiments tape movement occurs at wind loading between 5 and 60, 5 and 50, 5 and 40 knots, 5 and 30 knots, or 5 and 25 knots

In some embodiments, at least 30% of the total number of zones comprising the portion of weft tape between two adjacent groups of warp elements have portions that rotate at least 10 degrees under a wind load of 5, 8, 10, 15, 20, 25, 30, 35, 40, 45, 50, 55, 60, or 65 knots. In other embodiments, the weft tapes have portions that rotate at least 20, 30, 40, 50, 60, 70, 80 or 90 at the wind loads just mentioned. For clarity, the ‘zones comprising the portion of weft tape between two adjacent groups of warp elements’ are hereinafter referred to as ‘weft tape segments’. The degree of billowing or twisting or rotation as discussed herein with reference to weft tapes refers to the degree of twisting or rotation that a portion of a weft tape undergoes from its resting state (i.e. from a state not under wind load). Typically, weft tapes will lie in the same plane as the woven fabric that they form when not under wind load. A billowing or twist or rotation of at least 10 degrees would refer to a twist or rotation of a portion of a weft tape of at least 10 degrees from its resting state. In some embodiments, at least 40% of the total number of weft tape segments have portions that move at least 10 degrees under a wind load of 5, 8, 10, 15, 20, 25, 30, 35, 40, 45, 50, 55, 60, or 65 knots. In other embodiments, the weft tapes have portions that rotate at least 20, 30, 40, 50, 60, 70, 80 or 90 at the wind loads just mentioned. In some embodiments, at least 50% of the total number of weft tape segments have portions that move at least 10 degrees under a wind load of 5, 8, 10, 15, 20, 25, 30, 35, 40, 45, 50, 55, 60, or 65 knots. In other embodiments, the weft tapes have portions that rotate at least 20, 30, 40, 50, 60, 70, 80 or 90 at the wind loads just mentioned. In some embodiments, at least 60% of the total number of weft tape segments have portions that move at least 10 degrees under a wind load of 5, 8, 10, 15, 20, 25, 30, 35, 40, 45, 50, 55, 60, or 65 knots. In other embodiments, the weft tapes have portions that move at least 20, 30, 40, 50, 60, 70, 80 or 90 at the wind loads just mentioned. In some embodiments, at least 70% of the total number of weft tape segments have portions that move at least 10 degrees under a wind load of 5, 8, 10, 15, 20, 25, 30, 35, 40, 45, 50, 55, 60, or 65 knots. In other embodiments, the weft tapes have portions that rotate at least 20, 30, 40, 50, 60, 70, 80 or 90 at the wind loads just mentioned.

In some embodiments the spacing between adjacent groups of warp elements is greater than a minimum spacing, the minimum spacing being defined by a minimum wind permeability, wherein increasing the spacing between adjacent groups of warp yarns above the minimum spacing increases the wind permeability and decreasing the spacing between adjacent groups of warp yarns below the minimum spacing decreases the wind permeability.

In some embodiments the distance between adjacent cross over points, as measured along a pair of warp elements, is less than the width of the weft tapes so that the weft tapes are folded at each group of warp elements.

In some embodiments the width of the weft tapes is between 1 and 5 mm, 5 and 10 mm, 10 and 15 mm, 15 and 20 mm, 20 and 25 mm, 25 and 30 mm, 30 and 35 mm, 35 and 40 mm, 40 and 45 mm, or 45 and 50 mm.

In some embodiments the thickness of the weft tapes is 10 to 150 microns, or 15 to 100 microns, or 20 to 90 microns, or 25 to 75 microns.

In some embodiments the warp yarns may have a weight of about 250 denier to 1000 denier and in one preferred embodiment a weight of about 500 denier.

In some embodiments the weft tapes may have a weight of about 600 denier to 2500 denier and in one preferred embodiment a weight of about 1100 denier.

In some embodiments the distance between adjacent cross-over points is less than the width of the weft tapes so that the weft tapes are folded at each group of warp elements, and the spacing between adjacent groups of warp yarns is sufficient that segments of the weft tapes between the warp elements are not folded, so that adjacent weft tapes overlap or abut between adjacent groups of warp elements. The folding of the weft tapes occurs due to the warp tapes wrapping around the weft tapes. The amount of fold is determined by the width of the weft tape relative to the size of the space between two adjacent cross-overs of a group of warp tapes.

In some embodiments the width of the weft tape is at least twice the distance between adjacent cross over points. In some embodiments the construction of the weave is such that the distance, as measured along a pair of warp elements, between cross-overs is about 1 mm and the width of the warp tapes is about 2.6 mm.

In some embodiments the spacing between adjacent cross-over points, as measured along a pair of warp elements, is greater than the width of the weft tapes so that a gap exists between adjacent warp tapes. In some embodiments the spacing between adjacent groups of warp elements is at least three times, or five times, or ten times or twelve times the width of the weft tapes. In some embodiments the spacing between adjacent cross over points is up to 20%, 40%, 80%, 150%, 200%, 250%, 300%, 400% or 500% or more greater than the width of the warp tapes.

In some embodiments the material has a cover factor of at least 10%, 20%, 30%, 40%, 50%, 60%, 70%, 80%, 85%, or 90% or 95%, or about 95%.

In some embodiments the crop material has a weight of less than 200 gsm, or 150 gsm, or 100 gsm, or 95 gsm, or 90 gsm, or 85 gsm, or 80 gsm, or 75 gsm, or 70 gsm, or 65 gsm, or 60 gsm, or 55 gsm, or about 80 gsm.

In some embodiments the warp elements are monofilaments. In some embodiments the warp elements are tapes. Other embodiments may comprise a combination of monofilaments and warp tapes, the distribution of the monofilaments and warp tapes appropriate according to the properties desirable in a particular area of the material. In an alternative embodiment, the group of warp elements may comprise either a single monofilament or a single tape. In some embodiments each group of warp elements comprises two or more monofilaments. In some embodiments each group of warp elements comprises two or more tapes. In some embodiments each group of warp elements comprises one filament and one tape.

In some embodiments the construction is such that wind permeability is different in different regions of the material. For example, in a lower part of a vertically arranged wind break material, it may be desirable to have higher wind permeability at the bottom and lower permeability at the top, or vice versa.

In another aspect the present invention provides a method of protecting a plant against wind comprising providing over and/or adjacent the plant a material as described above.

In a further aspect the present invention provides a method of protecting a plant against birds, insects, sun, or hail comprising providing over and/or adjacent the plant a material as described above.

Preferably the width of the material is substantially uniform along the length of the material.

In some embodiments the warp elements and or weft tapes may be any of the following:

black, white, white (UV or non-UV reflecting white) in colour, non-white or black coloured, a combination of non-white or black colours, formed from a non-pigmented material, formed from plastic, or formed from a range of polymers.

In some embodiments the warp elements are formed by single, twin, triple, or other multiple monofilament fibre yarns. In one form the yarn is monofilament. Preferably, the monofilament has a substantially circular cross-section. More preferably the yarn has diameter in the range of approximately 0.1 mm to 1 mm, even more preferably 0.2 mm to 0.8 mm, and even more preferably 0.2 mm to 0.4 mm, and more preferably 0.2 to 0.3 mm and most preferably 0.15 mm to 0.25 mm In denier, the yarn is preferably in the range of approximately 50 to 1000 denier, more preferably 50 to 700 denier, even more preferably 100 to 500 denier, even more preferably 100 to 300 denier, even more preferably 150 to 250 denier or even more preferably 200 to 300 denier. In an alternative preferred embodiment, the yarn is in the range 450 to 550 denier, more preferably about 500 denier.

Preferably the weight of the crop material is in the range of approximately 10 to 200 grams per m². In alternative embodiments, the weight of the crop material is in the range of approximately 15 to 120 grams per m², or 30 to 110 grams per m², or 40 to 100 grams per m², or 50 to 90 grams per m², or 70 to 80 grams per m².

In a further aspect the invention broadly consists in a method of protecting plants comprising the step of at least partially covering a plant or row of plants with a crop material as described above.

In some embodiments the material is positioned next to a row of plants on the side of the prevailing wind, rather than over the plants. For wind, the material is typically large enough to protect an entire row of plants. It may be secured to posts or other structures either at the edges or along the length and/or width of the material. In one form the step of covering the plant(s) comprises securing the crop material over the entirety of the plant(s) and securing or fixing it to the ground surface surrounding the plants. In another form the step of covering the plant(s) comprises suspending or supporting the crop material over the top of the plant(s) as a canopy using a supporting structure or framework. In another form the step of covering the plant(s) comprises securing the crop material over the plant(s) to cover the top of the plants and go part way down the side of the plants.

In some embodiments the distance between the adjacent groups of warp elements is between 10 and 300 mm, 15 and 250 mm, 15 and 200 mm, 15 and 150 mm, 15 and 100 mm or 15 and 75 mm. In other embodiments the distance between adjacent groups of warp elements may be between 5 and 50 mm, 5 and 45 mm, 5 and 40 mm, 5 and 35 mm, 5 and 30 mm, 10 and 30 mm, 15 and 30 mm, or 20 and 30 mm. In other embodiments the distance between adjacent groups of warp elements is between 2 and 200 mm, or 2 and 100 mm, 4 and 80 mm, or 10 and 60 mm.

In some embodiments the crop material is at least 2%, 5%, 8%, 10%, 20%, 30%, 40%, 50%, 60%, 70%, 80%, or 90% permeable to wind under wind load conditions of 5 knots. In some embodiments the crop material is at least 2%, 5%, 8%, 10%, 20%, 30%, 40%, 50%, 60%, 70%, 80%, or 90% permeable to wind under wind load conditions of 10 knots. In some embodiments the crop material is at least 2%, 5%, 8%, 10%, 20%, 30%, 40%, 50%, 60%, 70%, 80%, or 90% permeable to wind under wind load conditions of 20 knots. In some embodiments the crop material is at least 2%, 5%, 8%, 10%, 20%, 30%, 40%, 50%, 60%, 70%, 80%, or 90% permeable to wind under wind load conditions of 30 knots.

In some embodiments the crop material includes means, such as grommets or zones designed for penetration, for attaching fixing devices.

In some embodiments the crop material includes additional strengthening along one or more edges. This may be for the purpose of preventing tears beginning on an edge or for increasing the ability of the material to hold means for attaching fixing devices or the fixing devices themselves. The strengthening may be providing by warp tapes or monofilaments at low distance spacing.

In some embodiments the material may also incorporate a compound or compounds added to increase the extent to which the material reflects, absorbs and/or transmits radiation from the earth or from the sun when the material is placed over or adjacent to plants.

The warp elements and weft tapes may be formed from any suitable material, including plastic or polymer materials. Typically, they are extruded from a polymer resin. In particular they may be comprised of thermoplastic polyolefins such as polyethylene or polypropylene, for example, or a mixture thereof, or an ethylene alpha-olefin, or a polyester, or a biopolymer, or a blend of any of the foregoing. Certain plastics are particularly useful when present as minor or major components. Ethylene vinyl acetate (EVA), ethylene butyl acrylate (EBA), thermoplastic polyurethane (TPU), ethylene methyl acrylate (EMA) and elastomers are useful for imparting elasticity and other properties. Polyamides can be used to add strength. Polyesters, polyethylene terephthalate (PET), polymethylmethacrylate (PMMA) and polycarbonate may also be useful. Starch and other plant polymers are useful to increase biodegradability. The polymer or polymer blend may incorporate agents such as one or more pigments, UV stabilisers, or processing aids.

The term “wind permeability” of a material as used herein refers to the amount or volume of moving air in a flow against the material perpendicular to the plane of the material that passes though the material. For example, if under wind at a wind speed of 30 knots, the material permits 50% of the volume of air impacting the material to pass through the material, then the material has a wind permeability of 50%.

The term “tape” or “tapes” is includes longitudinally extending single filament elements having four sides when viewed in cross-section, such as a rectangular or square cross-section. It also includes longitudinally extending elements an oval or similar cross-section.

By “cover factor” is meant the percentage of the overall area of the crop material which comprises yarn such as monofilament or tape or a combination, forming the crop material itself, judged from perpendicular to the plane of the crop material when laid out flat, as opposed to air space in between the crop material. Thus if a crop material has a cover factor of 30% then the air space through the crop material would be 70% of the total area of the crop material. “Cover factor” can also be indicative of wind permeability. Cover factor may be assessed by taking a digital photograph of a section of material, and processing the image to assess the relative proportions of yarn and air space.

The term “warp element” means multi or mono filament yarns, threads, fibres or tapes in the warp direction. It includes longitudinally extending single filaments having four sides when viewed in cross-section, such as a rectangular or square cross-section, also longitudinally extending elements having a multisided cross-section such as a triangular or hexagonal cross-section for example, and also longitudinally extending elements having a circular or oval or similar cross-section (sometimes referred to hereafter as monofilament).

The term “comprising” means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

### BRIEF DESCRIPTION OF THE DRAWINGS

The invention is further described by way of example with reference to the accompanying drawings in which:

FIG. 1 is a schematic view from one side of an embodiment of a material of the invention under zero wind load.

FIG. 2 is a schematic view of the material of FIG. 1 under wind load; the arrows indicate wind.

FIG. 3 is a schematic view of an embodiment of a material of the invention but with closer warp tapes and lower wind permeability, under similar wind load conditions to FIG. 2; the arrows indicate wind.

FIG. 4 is a photograph of another embodiment of a material of the invention having a spacing between warp crossovers, in the warp direction, less than the width of the weft tapes, such that the weft tapes fold at the cross-overs.

FIG. 5 is a photograph of a further embodiment of a material of the invention with adjacent groups of warp elements spaced 24 mm apart in the weft direction.

FIG. 6 is a photograph of a further embodiment of a material of the invention with adjacent groups of warp elements spaced 16 mm apart in the weft direction.

FIG. 7 illustrates a sample of another embodiment of a material, made with differing spacing in the weft direction between some of the adjacent groups of warp elements.

FIGS. 8, 9 and 10 are similar to FIGS. 1, 2 and 3, but show embodiments of a material in which the distance between warp crossovers, in the warp direction, is less than the width of the weft tapes, thereby causing the weft tapes to fold at the regions of the weft tapes close to the warp elements.

FIGS. 11 and 11a show a sample of material of the invention under test, as referred to in the subsequent description of trials work.

### DETAILED DESCRIPTION OF EMBODIMENTS

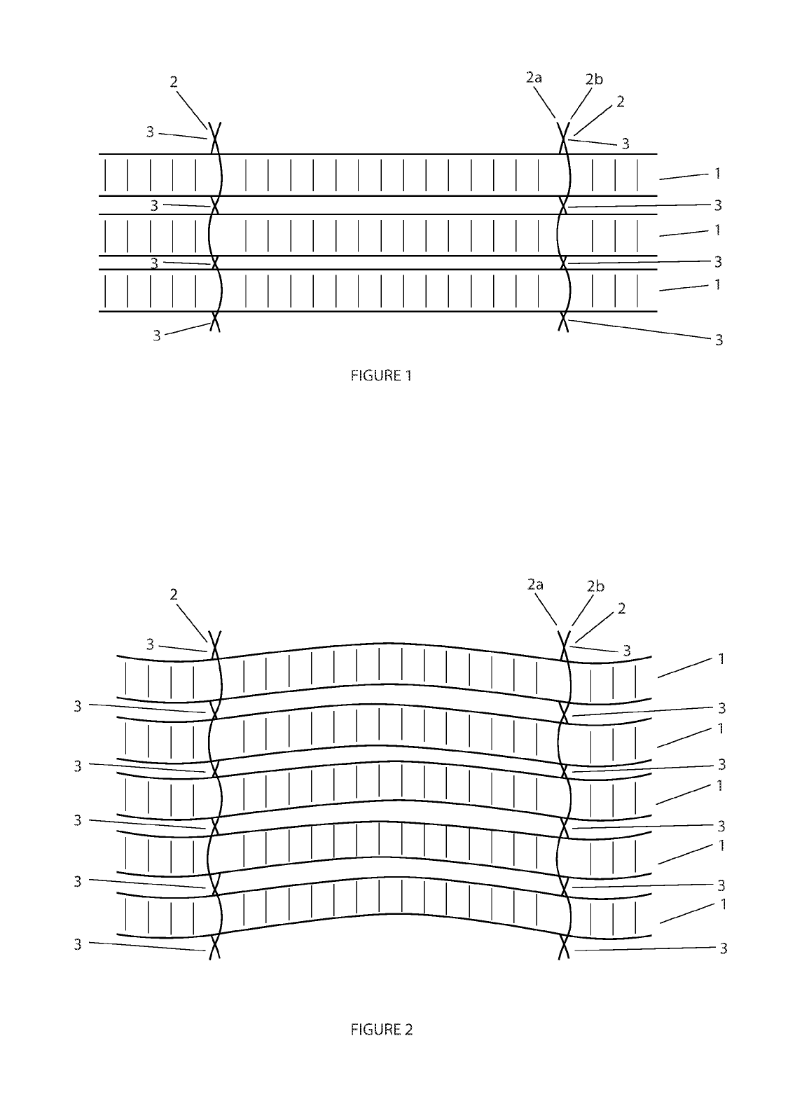

FIG. 1 is a schematic enlarged view of one embodiment of a crop material of the invention. The material is woven with a leno weave construction from weft tapes (1) and pairs (2) of warp elements (2a) and (2b), the pairs of warp elements (2) extending in the length of the material and spaced apart across the width of the material. The two warp elements (2a) and (2b) in each pair of filaments (2) cross at a cross-over point (3) between adjacent weft tapes (1) so that the warp filaments extend over and under adjacent weft tapes alternatively. In accordance with the invention the groups of warp elements (2, for example 2a and 2b) are spaced from each other across the weft at greater than about 8 mm, or in some embodiments greater than about 12 mm, greater than about 16 mm greater than about 18 mm, or greater than about 24 mm.

The adjacent groups of warp elements may be spaced across the weft at a spacing that may allow wind to pass through the material between weft tapes more easily than for an otherwise equivalent material with the same coverage but closer warp elements. That is, for a given coverage, the material of the invention may have higher wind permeability and/or wind permeability which increases with wind speed, relative to a similar material with closer spaced warp elements.

The adjacent groups of warp elements may be spaced across the weft at a spacing that allows the weft tapes to move under increased wind speed, to increase volumetric wind flow through the material greater than due to increase in wind speed alone. That is, the wind permeability of the material increases with increase in wind speed, at least at or over some range(s) of wind speed. The material is typically longer in the warp direction such as ten or twenty or fifty times longer, than it is wide in the weft direction.

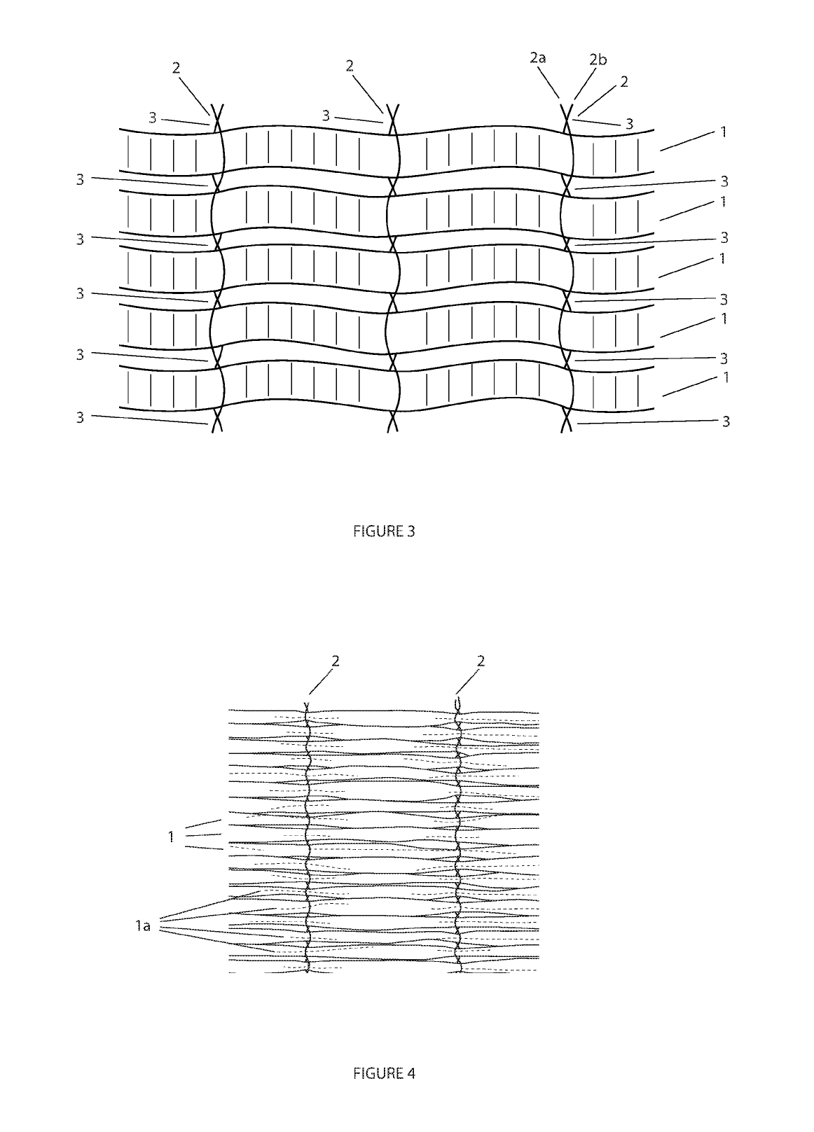

FIG. 2 illustrates the crop material of the invention as shown in FIG. 1 but under wind load conditions. FIG. 3 illustrates a crop material under similar wind load conditions to the material of FIG. 2 but in which the groups of warp elements (2) are less spaced from each other than in the embodiment of FIGS. 1 and 2. Due to the closer spacing of groups of adjacent warp elements, less of the weft tape length between warp elements is able to move compared to the material of FIG. 2, at similar wind loading. The material therefore has less wind permeability. Typical prior art leno weave materials have groups of warps elements that are closer again than illustrated, and do not allow movement of the weft tapes under wind load and accordingly the wind permeability of such fabrics does not change under wind load. Leno weave fabrics are not commonly used for crop purposes and in particular are not used to provide wind protection for crops. Presently, most wind breaks are comprise knitted not woven materials.

Forming a leno weave material of weft tapes (1) comprised of materials flexible enough, and warp elements (2) sufficiently spaced in the weft direction, may allow the weft tapes to move for example billow as shown in FIGS. 2 and 3 and/or at least partially twist or rotate under wind load conditions. The wind permeability of the fabric may increase or decrease as wind load increases or decreases. Increasing the spacing between the adjacent groups of warp elements (2), thus increasing the length of weft tape segments between adjacent groups of warp elements will increase wind permeability of the fabric at a given wind load. The distance between the adjacent groups of warp elements (2) should not be such as to result in the structural integrity of the weave being inadequate.

The tendency of the weft tapes (1) to move for example billow under wind load is primarily a function of the distance between adjacent groups of warp elements and secondarily of: the material of which the weft tapes are comprised; the width of the warp tapes; and the thickness of the warp tapes. And also of: the distance (as measured along a pair of warp elements) between the cross-overs; the material of which the warp tapes are comprised; and the thickness of that material.

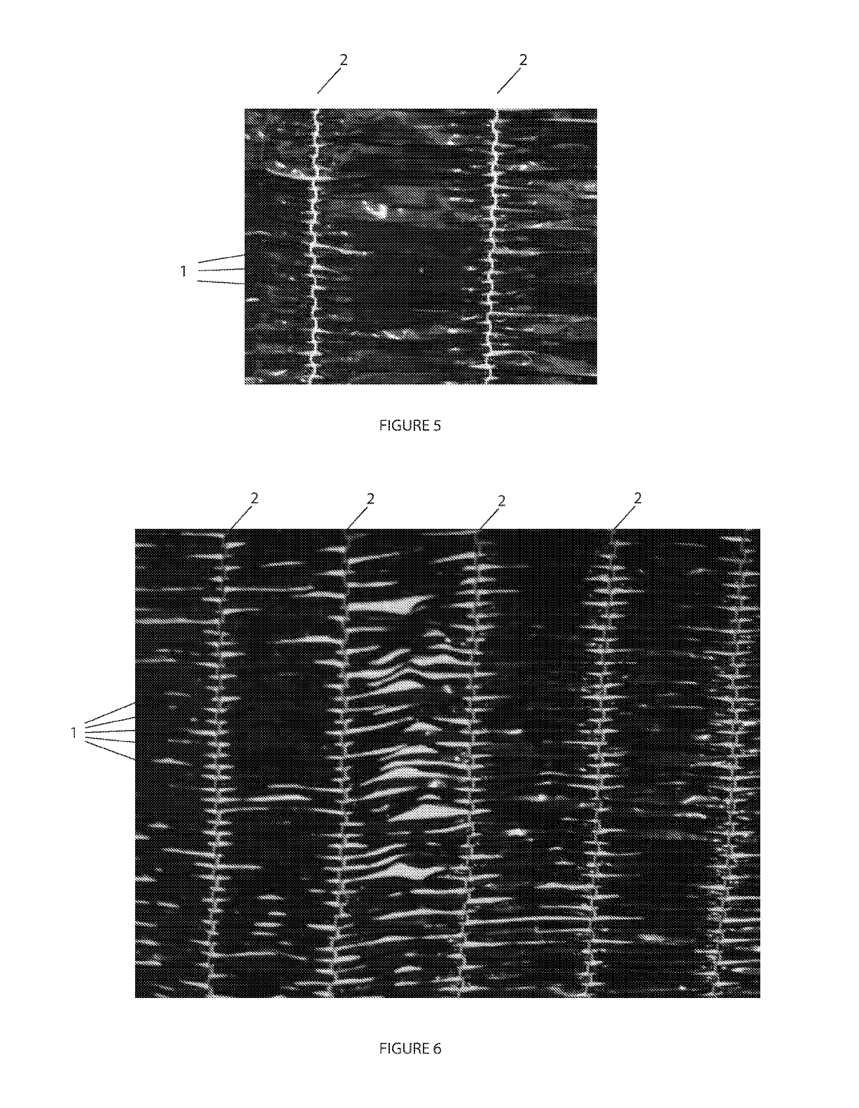

FIG. 5 is a photograph of an alternative material of the invention with adjacent groups of warp elements spaced 24 mm apart. FIG. 6 is a photograph of another alternative material of the invention with adjacent groups of warp elements spaced 16 mm apart. In FIG. 6 some of the weft tapes of the central portion of the material as photographed have been lifted illustrating the effect of wind upon the material.

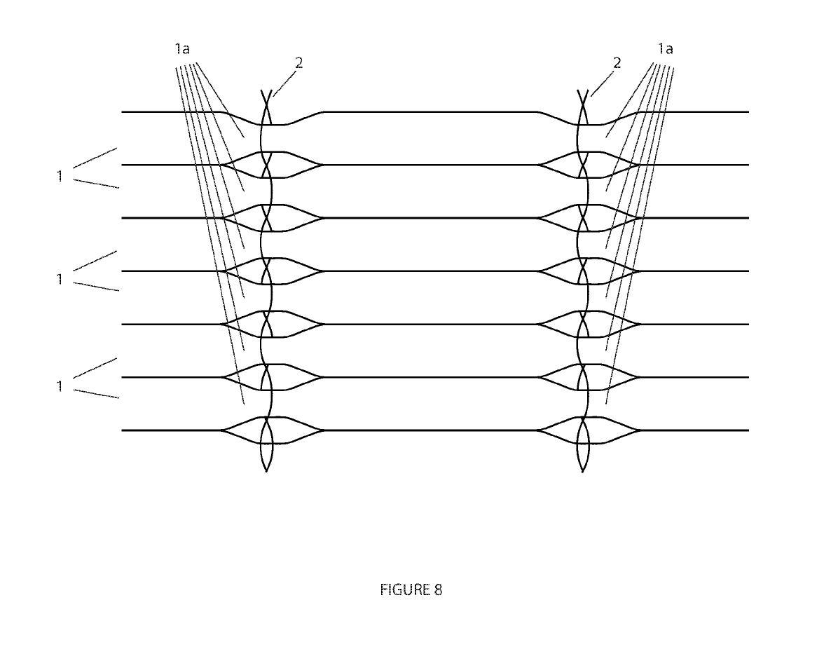

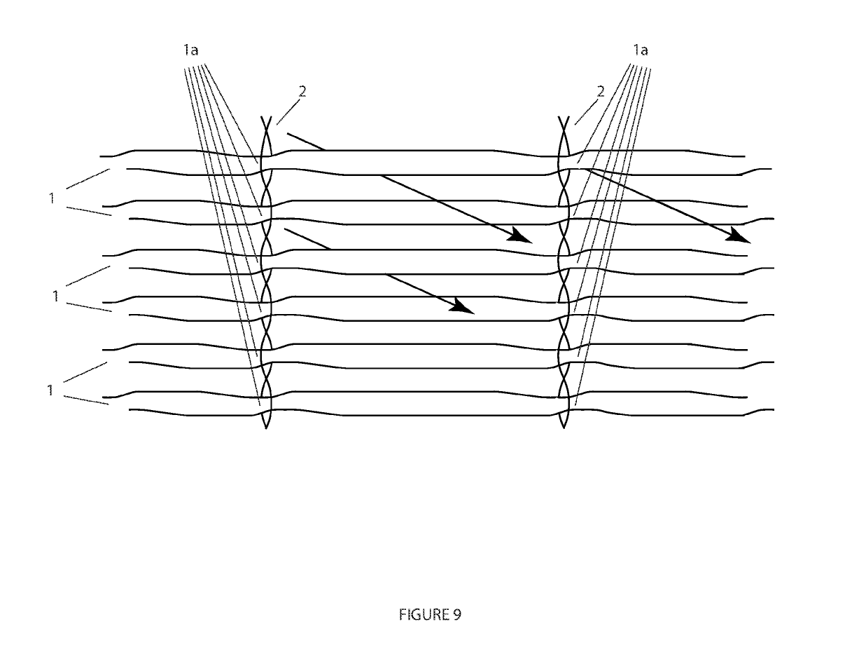

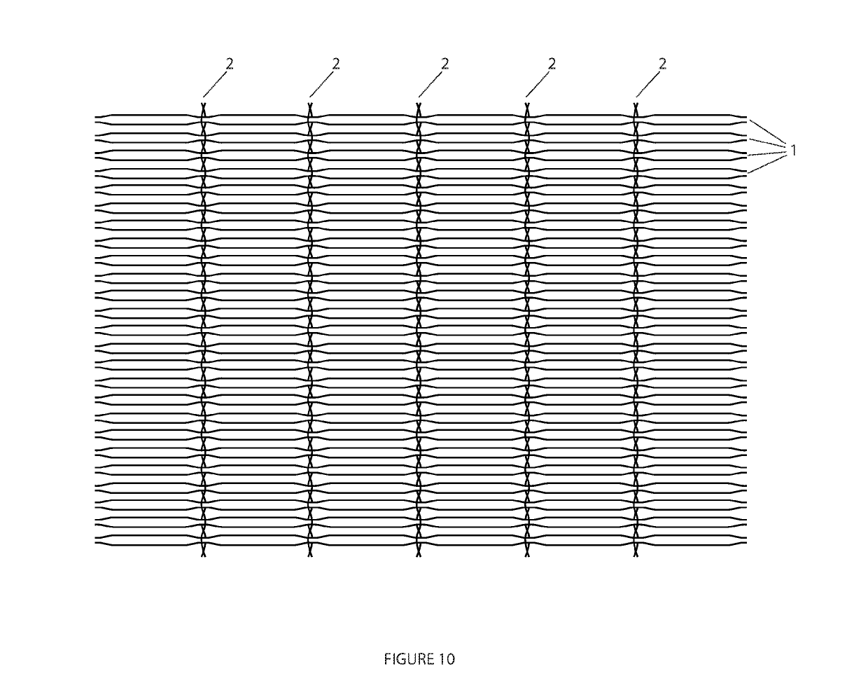

When the spacing, as measured along a pair of warp elements, between the cross-overs is less than the width of the weft tapes, the weft tapes will fold. FIG. 4 illustrates such a material. FIG. 4 is a photograph of an alternative material of the invention having a spacing between cross-over points (3) in the weft direction less than the width of the weft tapes, such that the weft tapes lengthwise fold at the cross-overs (3) (as indicated at 1a). FIGS. 8, 9 and 10 are similar to FIGS. 1, 2 and 3 but like FIG. 4 show embodiments in which the weft tapes are lengthwise folded at the warp cross over points (3). Again, in these embodiments, the warp elements are woven tightly around the weft tapes so that the warp elements compress each tape to bunch or fold the tape between the warp elements at the warp cross over points. However, the spacing between adjacent pairs of warp elements is sufficient that weft tape segments between adjacent pairs of warp elements are not folded, so that adjacent weft tapes overlap or abut between adjacent pairs of warp elements. The overlapping or abutting weft tapes result in a high cover factor to provide a high level of shading. This contrasts with prior art leno woven materials where a leno weave is used to provide an open weave to allow light and air to pass through the woven material. In these embodiments, folding of the weft tapes at the warp cross-over points can play an important role in the variability of wind permeability of the material. More specifically, under wind loading a folded weft tape, or at least the portion of a weft tape that is folded, is less likely to move for example billow than a weft tape that is not folded. As mentioned above, the more each weft tape moves, the more wind permeable the material becomes. Accordingly, the proportion of a weft tape that is folded compared to the proportion of the weft tape that is not folded may be a determinant of both wind permeability and the variability of that permeability as wind load increases/decreases.

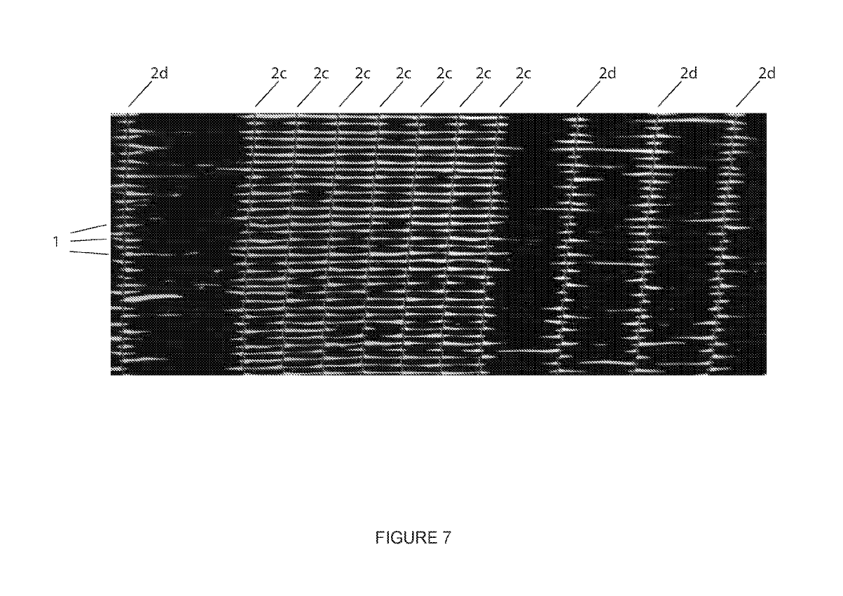

Also, in the embodiment of FIG. 7 the spacing in the weft direction between warp elements (2d) at sides of the material is different to, and in the embodiment shown greater than but could be less than, the spacing in the weft direction between warp elements (2c) at the centre of the material. Thus such embodiments comprise side lengthwise extending regions and a centre lengthwise extending region. Each side lengthwise extending region may have a width of for example at least about 20 cm, or about 50 cm, or about 80 cm, in which the warp spacing is more than that of the centre region. In some embodiments the wind permeability in the side regions is more than that of the centre region at a wind speed of for example 10 knots or more. In yet alternative embodiments a material of the invention may comprise two lengthwise extending regions, not a centre and two sides, which have differing warp spacing.

In some embodiments the width of the weft tapes is between 1 and 5 mm, 5 and 10 mm, 10 and 15 mm, 15 and 20 mm, 20 and 25 mm, or 25 and 30 mm. In other embodiments width of the weft tapes is between 1 and 30 mm, 1 and 25 mm, 1 and 20 mm, 1 and 15 mm, 1 and 10 mm, 1 and 5 mm, or 1 and 3 mm. The weft tapes preferably have a width many times their thickness such as at least two, 20, 50, 100, 200, 300, 500, 700, or 1000 times their thickness. In some embodiments the thickness of the weft tapes is about 25 to 75 microns. In some embodiments the warp yarns may have a weight of about 250 denier to 1000 denier and in one preferred embodiment a weight of about 500 denier. In some embodiments the weft tapes may have a weight of about 600 denier to 2500 denier, and in one preferred embodiment a weight of about 1100 denier.

In some embodiments the warp elements are monofilament yarn of circular in cross-section of any suitable material. Typically, the yarn is extruded from a polymer resin. Each yarn may be a single monofilament, or alternatively may comprise twin or multiple monofilaments. The monofilament preferably has a diameter in the range of approximately 0.1 mm to 1 mm, even more preferably 0.2 mm to 0.8 mm, and even more preferably 0.2 mm to 0.4 mm, and even more preferably 0.15 to 0.3 mm and most preferably 0.15 mm to 0.25 mm. In denier (grams per 9000 metres of the yarn) the yarn is preferably in the range of approximately 50 to 1000 denier, more preferably 50 to 700 denier, even more preferably 100 to 500 denier, even more preferably 100 to 300 denier, even more preferably 150 to 250 denier or most preferably 200 to 300 denier. The monofilament may be stretchable or non-stretchable in length, and may be elastic or non-elastic. The material is relatively lightweight. Preferably the weight of the material is in the range of approximately 10 to 200 grams per m². In alternative embodiments, the weight of the material is in the range of approximately 15 to 120 grams per m², or 30 to 110 grams per m², or 40 to 100 grams per m², or 50 to 90 grams per m², or 70 to 80 grams per m².

The crop material of the invention may provide a high degree of wind permeability, as well a high cover factor. The crop material may have a cover factor (as herein defined) of more than 10%, 20% 30% 40%, 50%, 60%, 70%, 80% or 90%. However the leno construction, while providing a high cover factor, may also be lightweight. Where the weft tapes abut without overlapping or with minimal overlapping a high coverage factor may be achieved for a low weight per square meter of crop material, as well as providing good wind permeability. Accordingly, materials of the invention may provide a high coverage light weight shade material with less susceptibility to wind damage. In some embodiments the combination of the dimensions of the weft tapes, the distance between adjacent cross over points of the warp yarns in each pair of warp yarns, and the spacing between adjacent pairs of warp yarns provides a cover factor of at least 70% and a weight of less than 100 grams per square metre while providing good wind permeability.

In one preferred example of a material the warp tapes have a width of about 3 mm and thickness of about 0.050 mm, and the pairs of warp yarns are spaced apart by a distance of about 24 mm. The warp yarns have a thickness of about 0.285 mm. The distance between cross over points in each pair of warp yarns may be about 1 to 2 mm and preferably less than 2 mm. For these dimensions each tape is folded or bunched onto itself at each pair of warp yarns but is substantially unfolded for a substantial length between adjacent pairs of warp yarns to overlap or abut with adjacent tapes to provide a higher cover factor. In this embodiment the crop material has a weight of about 80 gsm and a cover factor of about 95%.

In some embodiments the width of the weft tapes is at least twice the distance between adjacent cross over points so that the weft tapes may unfold to overlap or abut adjacent weft tapes in between warp yarn cross over points. To allow weft tapes to be unfolded in between warp yarn pairs, in some embodiments the distance between adjacent pairs of warp yarns is at least three times, or five times, or ten times the width of the weft tapes. In a preferred embodiment the distance between adjacent pairs of warp yarns is about eight times the width of the weft tapes.

The combination of the width of the weft tapes and the spacing of the warp yarns can be altered to achieve a desired crop material weight and cover factor. In some embodiments the crop material has a cover factor of at least 85%, or 90% or 95%, or about 95%. In some embodiments the crop material has a weight of less than 100 gsm, or 95 gsm, or 90 gsm, or 85 gsm, or 80 gsm, or 75 gsm, or 70 gsm, or 65 gsm, or 60 gsm, or 55 gsm, or 50 gsm, or 45 gsm, or 40 gsm, or 35 gsm, or about 80 gsm.

In some embodiments the material comprises weft tapes having a thickness of about 25 to 75 microns and a width of about 20 to 30 mm, and monofilament warp yarns having a thickness of about 250 to 300 microns. In some embodiments the warp yarns may have a weight of about 250 denier to 1000 denier and in one preferred embodiment a weight of about 500 denier. In some embodiments the weft tapes may have a weight of about 600 denier to 2500 denier and in one preferred embodiment a weight of about 1100 denier. When weaving the warp yarns tightly over and under the weft tapes in the leno weave the distance between the warp yarn cross over points is determined by the tape cross section and also the cross section of the warp yarns. For a larger warp yarn cross section and/or tape cross section the further part the warp yarn cross over points will be and therefore the wider the tapes will need to be to overlap or abut in between the cross over points to provide a higher shade factor.

In a preferred leno construction as described the crop material has pairs of warp elements spaced across the width of the material and woven over and under the weft elements as in the known leno construction. However, in some embodiments there may be more than two warp elements grouped together, each group spaced apart across the width of the crop material. For example, each group of warp yarns could comprise a pair of warp filaments as known in the art, and a third filament twisted around the pair.

In some situations it may be desirable to have a material that has different wind permeability in different regions of the material. For example, it may be desirable to have a region or regions of higher permeability (e.g. a band or bands of higher permeability extending lengthwise along the material) that may act as a pressure release zone against high wind loads. FIG. 7 illustrates a sample of material illustrating how different wind permeability may be achieved in different regions of a material by varying the distance between adjacent groups of warp elements in different regions. FIG. 7 illustrates a sample of material made with differing distances between some of the adjacent groups of warp elements. As illustrated, the two adjacent groups of warp elements to the left of the photo are 24 mm apart, the next region of groups of warp elements are 8 mm apart, and those on the very right are 16 mm apart. A large proportion of each of the weft tapes in the 24 mm spaced region can twist or rotate under wind load. A slightly smaller, but still very significant, proportion of each weft tape in the 16 mm spaced region can also twist or rotate under wind load. The weft tapes in the 8 mm space region have very little or no ability to rotate under wind load. This is a result of the smaller distance between adjacent warp elements in this region, combined with the folding of the weft tapes as a result of the distance between crossovers being less than the width of the weft tapes. The 8 mm spaced region has the lowest wind permeability due to a combination of the additional warp elements and the rigidity of the weft tapes. Its permeability will be relatively unchanged as wind load increases, especially compared to the other regions of the material. This is despite the lower cover factor in the 8 mm region, which can be readily seen by the amount of light showing through the material in this region.

In an alternative embodiment again, what is described above as the weft tapes may run in the machine direction, i.e. the length of the material, and what is described above as the warp tapes may run across the machine direction i.e. across the width of the material, and this specification is to be interpreted accordingly.

### Experimental

The following description of trials work further assists in understanding of the invention:

Samples:

Three sample materials had tapes in the weft direction and pairs of monofilament yarns of circular cross-section in the warp direction, in a leno weave. The samples had the general configuration illustrated in FIGS. 4, 8, 9, and 10, with folds in the weft tapes at the warp cross-over points. The weft tapes were tapes extruded from a polyethylene resin pigmented with carbon black. The tapes had a width of 2.5 mm, denier of 1150, and a thickness of about 0.05 mm. The warp yarns were extruded from a polyethylene resin pigmented with white or black. The monofilaments had a thickness of 0.3 mm and denier of 500. Each sample material had a different distance between pairs of warp yarns or rate of tape insertion. The rate of weft tape insertion was 13-14 tapes per inch. The characteristics of the tape insertion rate and distance between warp monofilaments are listed in the table below.

Test Method for Measuring Wind Permeability:

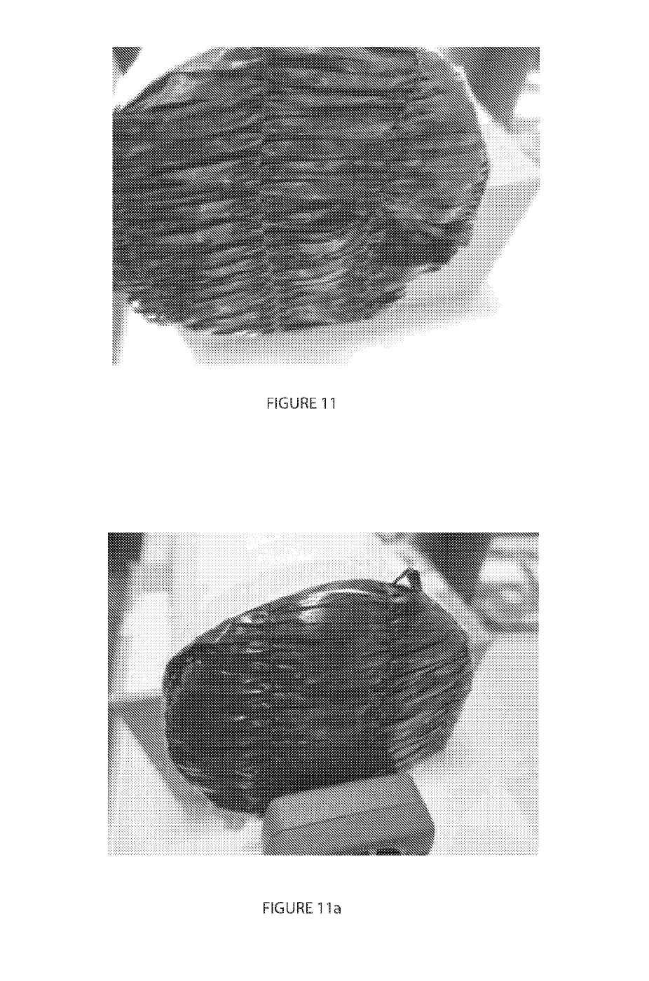

The same test was conducted on each of the samples. A funnel was attached to a wind generating device capable of creating variable air velocity. The funnel was 230 mm long and had an inner diameter of 215 mm at its widest point. The wind generating device was capable of producing six different wind speeds. The wind velocity was measured at each setting using an anemometer placed 10 mm from the end of the tube (Velocityᵢ). The control was the wind velocity measured with no sample on the end of the funnel at each of the six wind speed settings. Each sample was formed by taking a cutting 300 mm×300 mm from the materials being tested. Each sample was mounted to the end of the funnel so that it was perpendicular to the wind generating device, as shown in FIGS. 11 and 11a. The outer edge of the sample material was held flush against the funnel. The sample was taut, but not under high tension. The wind generating device was turned on and the air flow allowed to stabilise for approximately 5 seconds before a reading was taken. FIGS. 11 and 11a show a sample under test—FIG. 11a before turn on of the wind generating device and FIG. 11a with the wind generating device operating. The wind velocity was measured at each setting using an anemometer placed 10 mm from the end of the tube (Velocityₘ). The percent reduction in wind permeability was calculated using the equation:

(Velocityᵢ(km/h)−Velocityₘ(km/h))/Velocityᵢ(km/h)*100

Results:

The results are illustrated in the table below:

| | Sample 1 | Sample 2 | Sample 3 |
|---|---|---|---|
| Distance between warp | 24 | 16 | 8 |
| monofilaments (mm) | | | |
| Tape Width (mm) | 2.6 | 2.6 | 2.8 |
| Tape Denier (g/9000 m) | 1100D | 1100D | 1100D |
| Tapes Per Inch | 13 | 13 | 14 |
| Cover Factor (%) | 94.7 | 85.1 | 70.0 |
| Mass | 67.1 | 75.3 | 83.4 |
| Percent Wind Reduction Per | 0.6 | 0.6 | 1.0 |
| Fabric Cover Factor (%) | | | |

The results show that as the distance between the pairs of warp yarns increases, the percent reduction in wind permeability decreased relative to the fabric cover factor. When there was an 8 mm distance between the pairs of warp yarns, the percent reduction in wind permeability was 1.0% per fabric cover factor. As the distance between the warp yarns increased to 16 and 24 mm, this decreased to 0.6% reduction in wind permeability per fabric cover factor. That is, wind permeability was higher for fabric where the distance between the warp yarns was greater.

The foregoing describes the invention including preferred forms thereof. Alterations and modifications as will be obvious to those skilled in the art are intended to be incorporated in the scope hereof, as defined in the accompanying claims.

1. A crop material woven in a leno weave configuration from weft tapes and groups of warp elements spaced apart across the weft and with the warp elements in each group of warp elements crossing at cross-over points either side of and between generally all adjacent weft tapes and adjacent groups of warp elements spaced across the weft at greater than about 12 mm.

2. The crop material according to claim 1 wherein adjacent groups of warp elements are spaced across the weft at greater than about 16 mm.

3. The crop material according to claim 1 wherein adjacent groups of warp elements are spaced across the weft at greater than about 20 mm.

4. (canceled)

5. The crop material according to claim 1 wherein adjacent groups of warp elements are spaced across the weft at a spacing that allows wind to pass through the material between weft tapes more easily than for an otherwise equivalent material with the same coverage but closer warp elements.

6. The crop material according to claim 1 wherein adjacent groups of warp elements are spaced across the weft at a spacing that allows weft tapes to move in response to wind load such that volumetric wind flow through the material may increase at a rate greater than the rate of increase that would otherwise result from an increase in wind speed alone.

7. The crop material according to claim 1 wherein an increase in volumetric wind flow greater than volumetric wind flow through the material due to increase in wind speed alone occurs at a wind speed of more than 5 knots.

8. The crop material according to claim 1 wherein an increase in volumetric wind flow greater than volumetric wind flow through the material due to increase in wind speed alone occurs at wind speed of less than 5 knots.

9. (canceled)

10. The crop material according to claim 1 wherein cross-over points of warp elements in groups of warp elements, between adjacent weft tapes, are spaced in the warp direction by less than a width of the weft tapes and the weft tapes are lengthwise folded at cross-over points of warp elements.

11. The crop material according to claim 1 wherein cross-over points of warp elements in groups of warp elements, between adjacent weft tapes, are spaced in the warp direction by less than the width of the weft tapes and the weft tapes are lengthwise folded at each group of warp elements, and the width of the weft tapes and spacing between adjacent groups of warp elements allows weft tapes to substantially unfold so that adjacent weft tapes overlap or abut between adjacent groups of warp elements.

12. (canceled)

13. The crop-material according to claim 1 wherein cross-over points of warp elements in groups of warp elements, between adjacent weft tapes, are spaced in the warp direction by greater than the width of the weft tapes so that a gap exists between adjacent weft tapes.

14.-21. (canceled)

22. The crop material according to claim 1 wherein the warp elements are monofilaments with a substantially circular cross-section.

23.-24. (canceled)

25. The crop material according to claim 1 wherein the warp elements are tapes.

26.-30. (canceled)

31. The crop material according to claim 1 wherein the spacing between adjacent groups of warp elements is between 2 and 200 mm.

32. The crop-material according to claim 1 wherein wind permeability of the crop material is at least 2% at a wind speed of 5 knots.

33.-35. (canceled)

36. The crop material according to claim 1 comprising grommets or fastener penetration zones.

37. (canceled)

38. The crop material according to claim 1 also incorporating a compound or compounds which increases the extent to which the material reflects, absorbs and/or transmits radiation from the earth or from the sun when the material is placed over or adjacent to plants.

39.-40. (canceled)

41. The crop material according to claim 1 having a weight in the range of approximately 10 to 200 grams per m².

42.-43. (canceled)

44. The crop material according to claim 1 wherein a cover factor of the material decreases by at least 5% under a wind load of knots, compared to the material under zero wind speed.

45. The crop material according to claim 1 having a width less than a length and comprising a first lengthwise extending region and a second lengthwise extending region, each lengthwise extending region having a width of at least 20 cm, and wherein the spacing between adjacent groups of warp yarns in the first region is more than that of the second region, and wherein the wind permeability in the first region is more than that of the second region at a wind speed of 10 knots or more.

46.-48. (canceled)

49. The method of protecting a plant or plants comprising the step of at least partially covering a plant or row of plants with a crop material according to claim 1.

50.-55. (canceled)
